(19) United States
(12) Patent Application Publication
(10) Pub. No.: US 2013/0204731 A1
(43) Pub. Date: Aug. 8, 2013

(54) DIGITAL MEDIA DISTRIBUTION SYSTEM

(71) Applicants: Todd Smith, Louisville, KY (US); Nathan Moore, Nashville, TN (US)

(72) Inventors: Todd Smith, Louisville, KY (US); Nathan Moore, Nashville, TN (US)

(21) Appl. No.: 13/731,986

(22) Filed: Dec. 31, 2012

Related U.S. Application Data
(60) Provisional application No. 61/582,100, filed on Dec. 30, 2011.

(51) Int. Cl. G06Q 20/12

(52) U.S. Cl. CPC G06Q 20/123
USPC 705/26.1

(57) ABSTRACT

The system and method of this disclosure provides a digital media distribution system wherein the content producer interacts directly with the customers or fans of the content producer through the system. The content producer obtains the ability to use the distribution system by paying the owner of the system for access and usage rights. The system allows direct transactions to occur without such transaction occurring through a middleman who keeps a percentage of the transaction fees or through a gate-keeper who makes an editorial decision as to the worthiness and placement of the content within the gate-keeper's system.

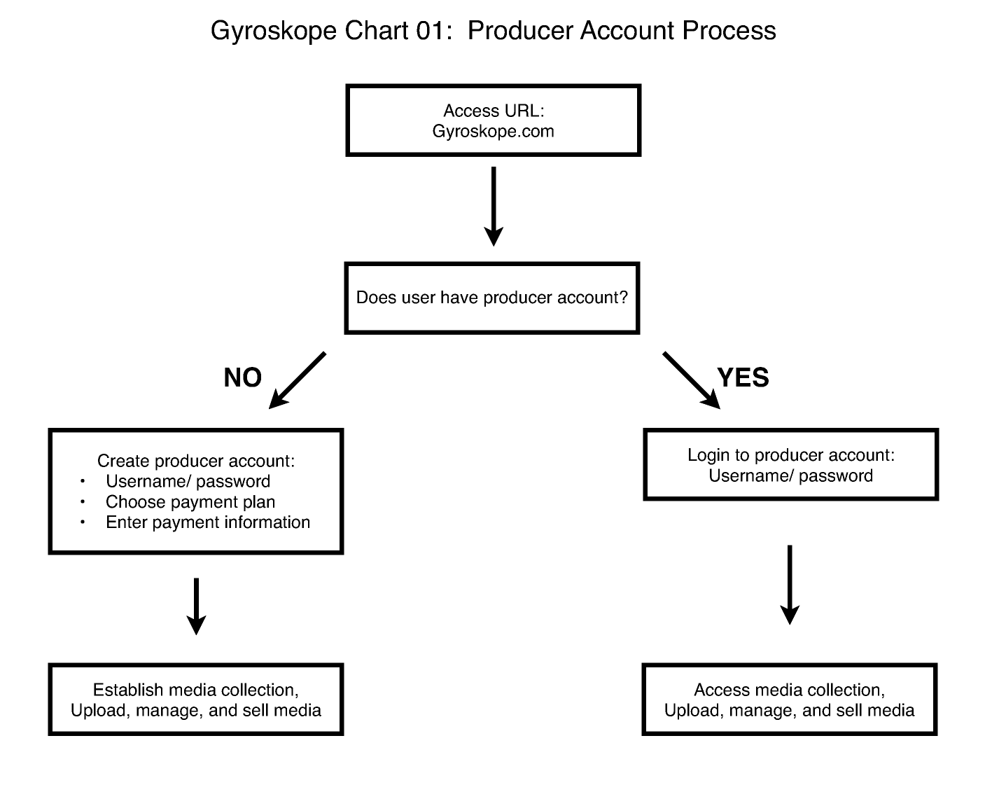

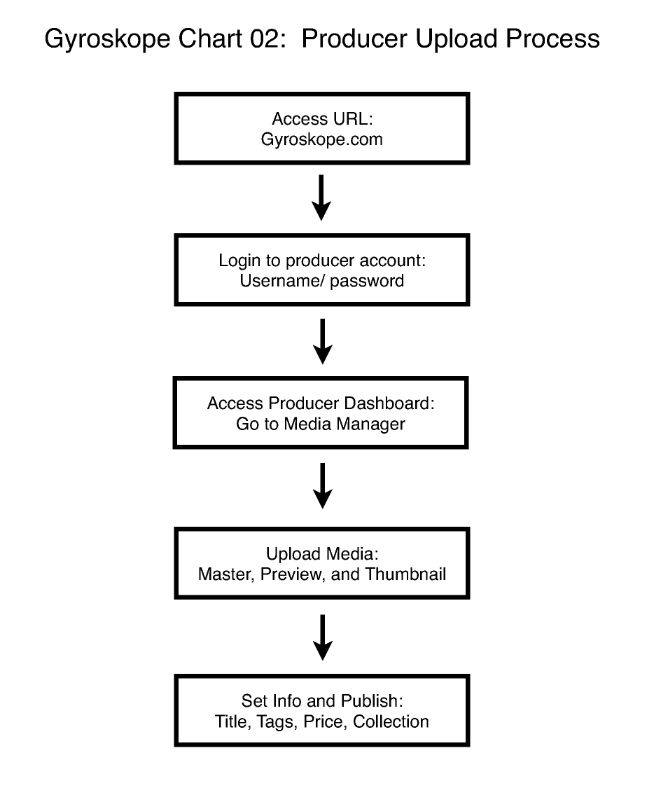

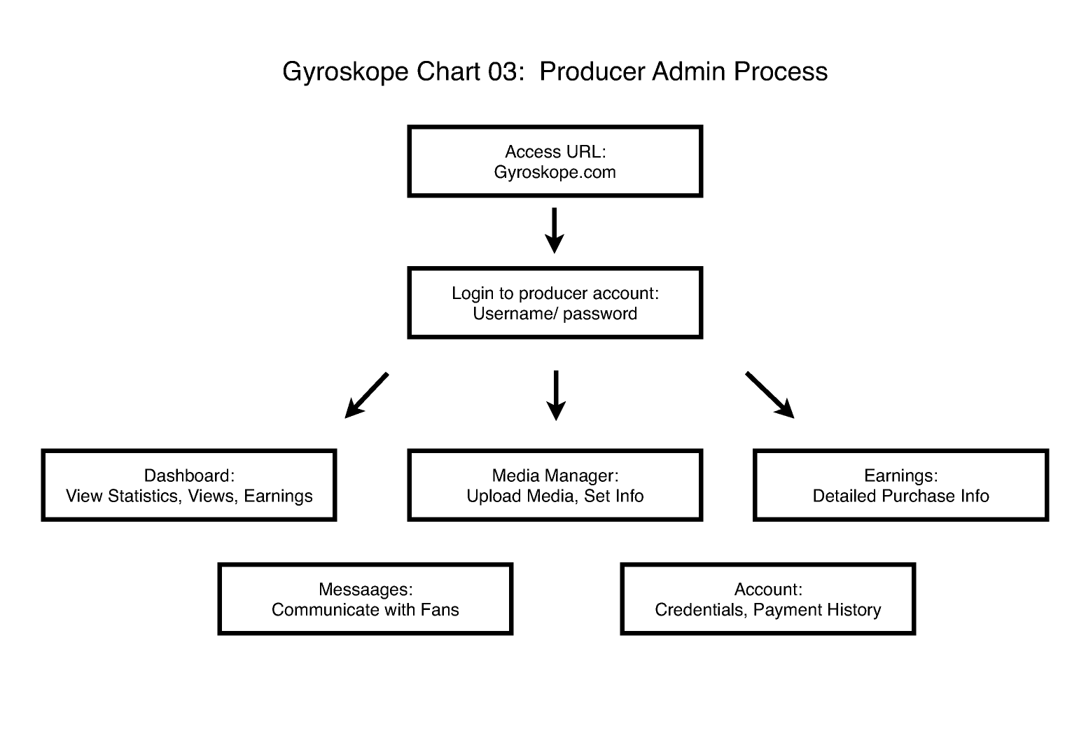

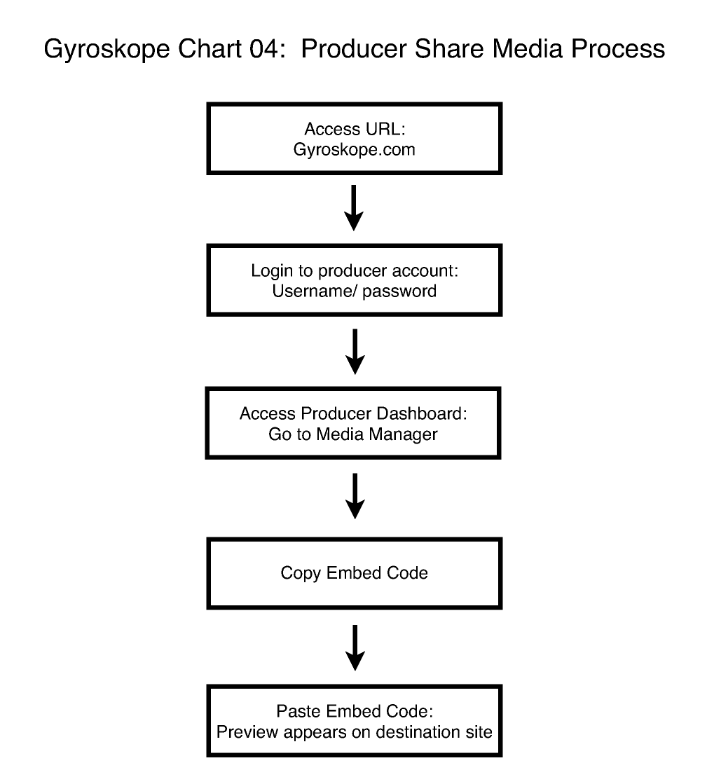

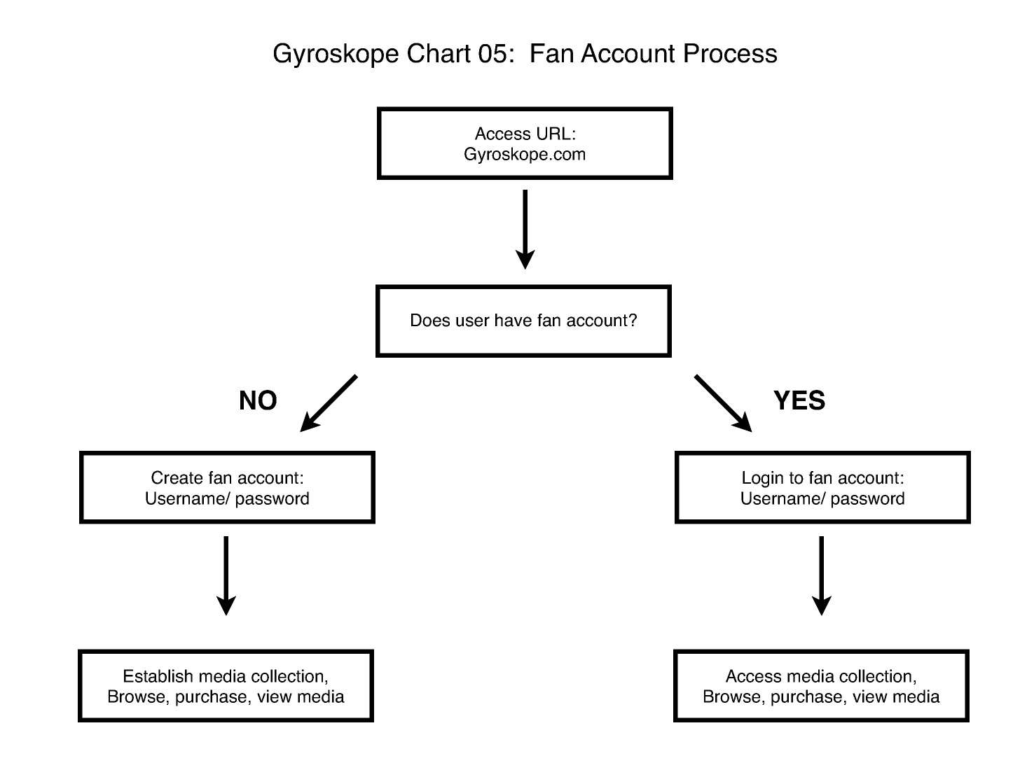

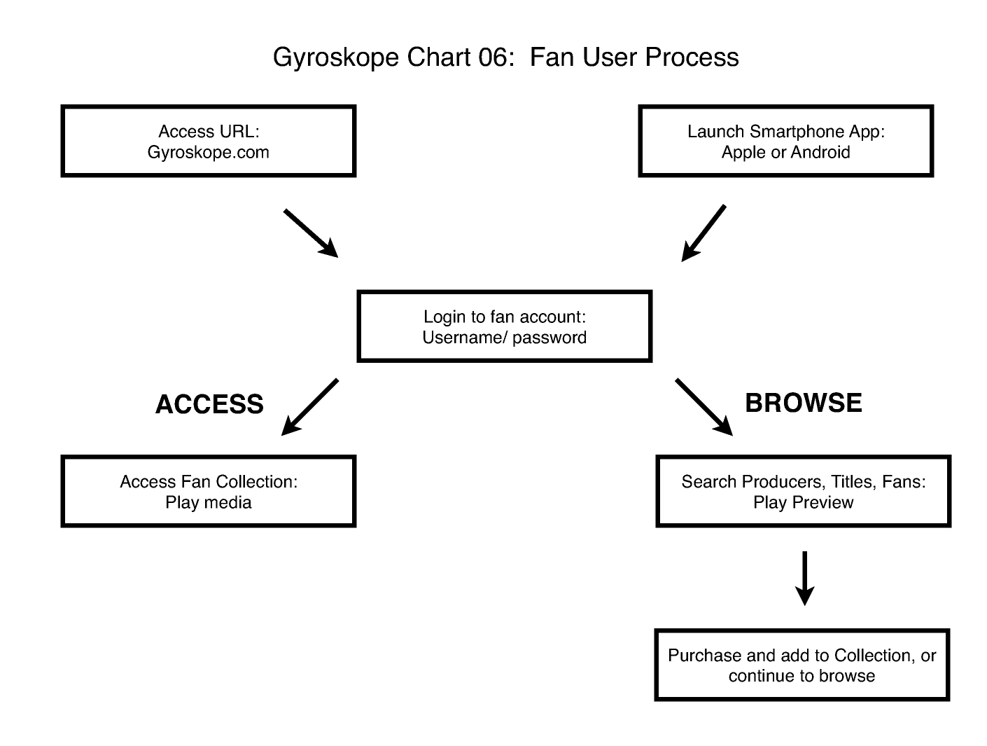

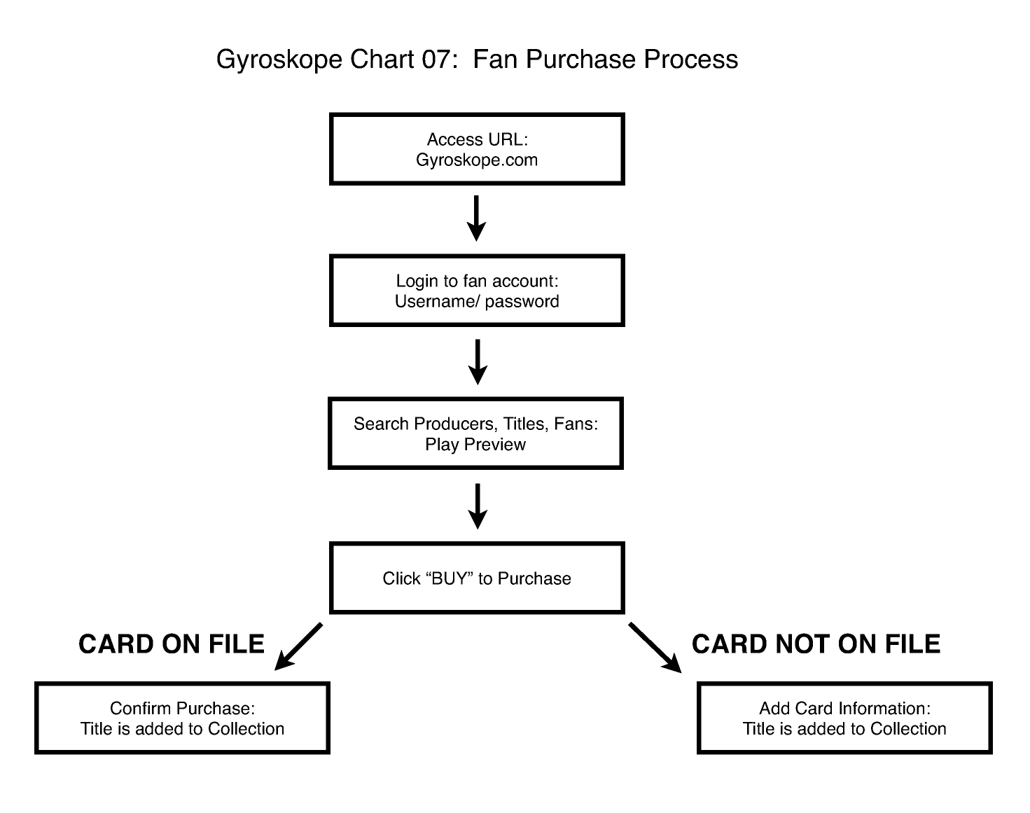

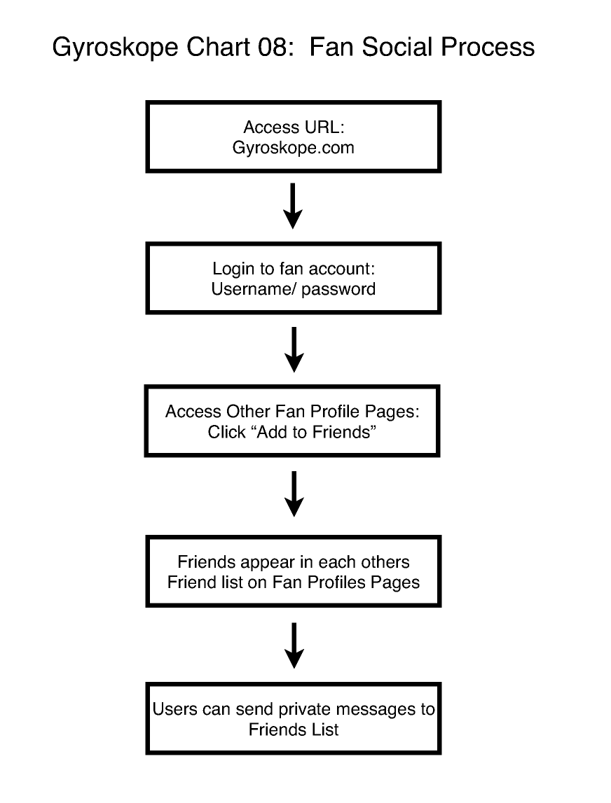

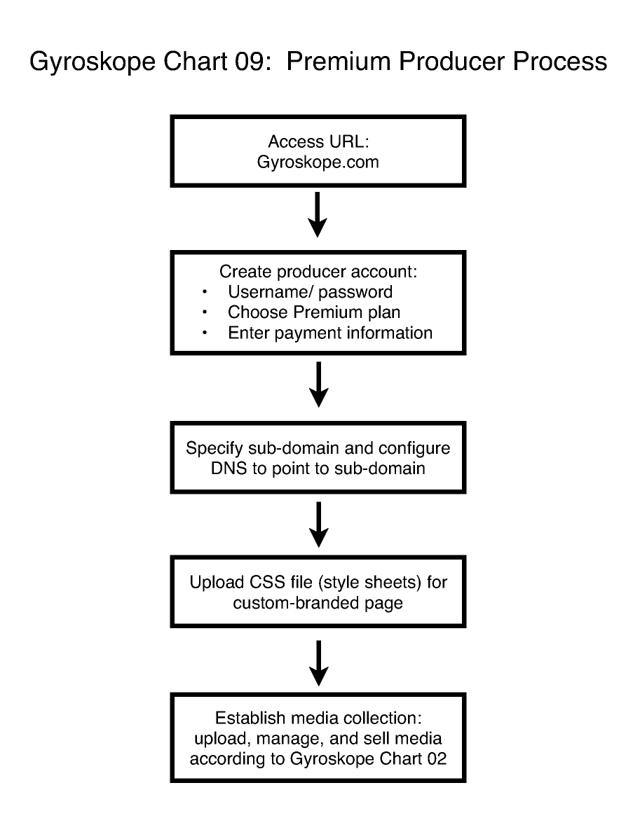

### CROSS REFERENCE TO RELATED APPLICATIONS

This application claims the benefit of U.S. provisional application Ser. No. 61/582,100 filed Dec. 30, 2011; the disclosures of which are incorporated herein by reference.

### TECHNICAL FIELD

The present disclosure generally relates to digital media distribution systems and methods and, more particularly, to a distribution system and method that allow content providers to distribute digital media directly to customers.

### BACKGROUND INFORMATION

There exist various web-based digital media streaming services, download services, retail services, and distribution services. Although these services function in different manners and have different features, they generally require the content producer to submit some element of control and/or profit to a gate-keeper or middleman in order to benefit from the system. The inventors of the system described in this disclosure understand there is an unfulfilled demand in the industry to provide a system that allows a content producer to license the usage of a distribution service that enables direct transactions between the content producer and the content producer's end users (customers or fans).

The inventors also recognize there is no currently existing service that allows such direct transactions to occur securely within a viral embeddable “widget;” i.e., a stand-alone and fully-functional mini-site that can live inside another website that is not owned or controlled by the content producer.

### SUMMARY OF THE DISCLOSURE

An object of the system is to provide a platform for digital content producers to distribute and monetize their work through a method that is reasonable and fair for producers and their customers or fans, and through a platform that is future-proof and aligned with the direction of media consumption paradigms (as much as possible in terms of known or anticipated technologies).

The system and method of this disclosure provides a digital media distribution system wherein the content producer interacts directly with the customers or fans of the content producer through the system. The content producer obtains the ability to use the distribution system by paying the owner of the system for access and usage rights. The system allows direct transactions to occur without such transaction occurring through a middleman who keeps a percentage of the transaction fees or through a gate-keeper who makes an editorial decision as to the worthiness and placement of the content within the gatekeeper's system. The system and method also provide the ability of the content producer to eliminate third party advertising from being associated with his content.

The disclosure also provides a digital media distribution system that allows direct transactions to occur securely within a viral embeddable “widget;” i.e., a stand-alone and fully-functional mini-site that can live inside another website that is not owned or controlled by the content producer. This is significant in that it allows the content to be distributed throughout the web, versus requiring customers to find their way to a destination site or point of sale. This method of distribution allows the content to follow the fans, versus forcing the fans to find the content.

The system described herein is the first digital media distribution service to offer all of the following in one service: (1) a monetization platform that allows digital content producers to sell directly to their end users and keep 100% of their revenue after paying the access fee; (2) a viral/embeddable share player that can process all stages of the transaction, from previewing, to creating the end user account, to processing payment, to viewing the content; (3) share player compatible with both flash and HTML5; (4) ad-free environment; (5) no editorial control of the platform by the owner of the system; and (6) no aggregation of content (the owner of the system does not function as a middle-man).

Digital content producers have plenty of options to distribute their work for free on the web. But there are few good options when it comes to monetizing content. The system described herein gives producers a solid platform to sell directly to fans, in a premium, ad-free environment. No ads: We believe that consumers value a premium experience. By allowing fans to directly support their favorite producers, Gyroskope creates a self-sustaining environment that eliminates the need for advertising. No gatekeepers: You worked hard on your production, and you don't need someone else to decide whether it's good enough to sell (subject to prohibitions on illegal content). By allowing a direct relationship between producers and fans, Gyroskope eliminates the gatekeeper. No middle men: When you sell through a middle man, he keeps a lot of your money. No advertising: the site owner can be prohibited by you from associating third party advertising with your content. With Gyroskope, producers pay a flat monthly fee to use the platform, and keep 100% of their sales revenue.

Another configuration of the system and method are provided by a Premium Producer account type, which may be the highest level of producer account available through the system. The Premium producer has the option and ability to host the core system and method functions inside of their own website environment, creating a seamless and custom-branded experience for their end-users or fans. Premium producers specify a sub-domain within their official domain on which the system's functions will reside. For example, if a producer's official website domain is “artist.com,” the producer may specify that the system's functions will reside at “videostore.artist.com.” The page at “videostore.artist.com” may be designed by the producer or the producer's web developer to look and feel exactly like the other pages within the producer's official site, thereby creating a seamless experience for the end-user.

### BRIEF DESCRIPTION OF THE DRAWINGS

Chart 1 is a flow chart showing how a content producer initially interacts with the system.

Chart 2 is a flow chart showing how a content producer uploads media to the system.

Chart 3 is a flow chart showing system options for the content producer.

Chart 4 is a flow chart showing how a content producer provides access to the system from a third party site.

Chart 5 is a flow chart showing how a customer (fan) of the content producer initially interacts with the system.

Chart 6 is a flow chart showing options for the fan using the system.

Chart 7 is a flow chart showing the purchase process for a fan.

Chart 8 is a flow chart showing social media options for the fan.

Chart 9 is a flow chart showing the Premium Producer Process.

Similar reference numerals and names of features are intended to refer to similar items throughout this description.

### DETAILED DESCRIPTION OF THE DISCLOSURE

The system described herein is a web-based service that allows digital content producers to distribute and sell their content directly to their fans. The system operates under the trademark GYROSKOPE. The Gyroskope™ widget is the name of a widget that can be embedded into any other website allowing the content to follow the fans. There are two ways to experience the service: (1) as a content producer and (2) as a content fan.

In general the system is a digital media distribution website capable of storing or accessing stored digital media files for content producers who have paid the system owner. The system then serves the digital media files to fans that have paid the content producer for the right to access the media files. When instructed by a paying fan, the system streams the content to a fan who has purchased the right to have access to the content. In one configuration, the fan may be permitted to download a copy of the content if the fan continuously accesses the same item of content or if the content producer is terminating his account and removing his content from the system.

As shown in Chart 01, a content producer may use the system by creating an account on the system and choosing a payment plan that provides different amounts of storage, different bandwidth access, and different numbers of videos. In one example, the payment plan is a monthly charge that defines storage, bandwidth, and the number of videos that may be uploaded for sale. In one example, the content producer is provided with three choices of: Option 1 (Basic): $19/month for 10 GB storage, bandwidth of 50 GB/month, and a maximum of 5 videos; Option 2 (Pro): $79/month for 50 GB storage, bandwidth of 200 GB/month, and a maximum of 25 videos; Option 3 (Premium): $499/month for 500 GB storage, bandwidth of 1 TB/month, and no limit on the number of videos. In each of these options, the system will pass credit card transaction fees through to the content producer. In each of these options, the system may charge the content producer for bandwidth overages. In one example, additional bandwidth is charged in 100 GB increments for $30. In each of these options, the content producer may obtain additional storage for an additional fee. In one example, additional storage may be purchased for $5/month for 5 GB.

Chart 2 describes the upload process for the content producer. After the content producer has paid the flat monthly fee to use the system, the content producer sets its own price payable by the fan who wishes to have access to the digital file through the system. The owner of the system does not function as a gatekeeper for the content that is uploaded. The content producer thus has total control of what content is provided for sale to his fans with the use of the system being free of a gatekeeping system owner who is selecting which content is provided, formatting content, and pricing content. The gatekeeper function may be limited to terms of a user agreement that prohibits illegal materials or other limitations that are accepted by the content producer before paying the monthly access fee. The method and system also provide the content producer the option of eliminating all third party advertising from his page of the owner's website or from any of his content. This feature allows the content producer to opt out of advertising so that the owner of the system cannot associate advertising with the content producer. The content producer keeps 100% of the sales revenue related to content purchases less any third party payment processing fees. Such third party payment processing fees include, but are not limited to, credit card or debit card processing fees. Such fees are the responsibility of the fan or content producer and are not paid by the operator of the system. In one configuration, the content producer is automatically paid 100% of sales revenue (less any expenses such as third party processing fees) after the next monthly fee is covered by collections posted to his account. When sales exceed the monthly account charge, a payment is sent to the content producer. The payment may be sent via an electronic funds transfer, a wire transfer, a PayPal® payment, a credit to a credit or debit card, or a check may be mailed.

After the content producer has uploaded a media file to the system, the system generates a link (such as an HTML link) that may be distributed to potential customers via other website or email. Such a link or a preview package also may be generated at a later time such as by the method described in Chart 4.

Chart 3 describes usability features for the content producer. The content producer is able to manage its media, track its sales, and communicate with its fans.

If the content provider chooses to cancel its account, the fans of the content producer will have an opportunity to download any titles purchased from the content producer.

The following outlines provide the basic functionalities for the different users of the system.

### Content Producer Experience:

1. visit website

2. select pricing plan

3. create account
a. input name
b. input email address
c. create password
d. confirm password\
e. agree to terms of service
f. input credit card information
   i. card type
   ii. card number
   iii. expiration date
   iv. security code
g. click “Create Producer Account”

4. Once producer account is created, producer is logged in.

5. Once logged in, the producer has the following options:
a. Dashboard
   i. view traffic
   ii. view purchases
   iii. view profits
   iv. view fan count
b. Media Manager
   i. add new videos
   ii. edit existing video information
   iii. view videos in your library
   iv. get code to embed or share videos out to the web
c. Earnings
   i. realtime stats of YTD
   ii. realtime stats of current month
   iii. realtime stats of pending sales
   iv. realtime stats of number of purchases
d. Messages—ability to send messages to end users who have purchased titles
e. Account
   i. edit account settings
   ii. edit payment settings
   iii. view account history
   iv. switch producer plans

### Fan Experience From Web:

1. visit website

2. create account
a. input name
b. input email address
c. create password
d. confirm password
e. agree to terms of service

3. Once fan account is created, fan is logged in.

4. Once logged in, fan has the following options:
a. Collection—view purchased titles from any producer
b. Messages—view and respond to messages from producers you have purchased content from
c. Account
   i. edit account settings
   ii. edit payment settings
d. History—view purchase history
   Fan Experience from Embedded Gyroskope Widget:

1. Discover embedded Gyroskope™ widget on any website on which the widget has been embedded by a producer.

2. The Gyroskope™ widget has three tabs:
a. Sample: this tab allows fan to view trailer or sample clip of title that is available for purchase.
b. Full: this tab allows fan to create account, or log in if they already have account, and purchase the full version.
c. Account: this tab allows the fan to link to the site to login to their account and access full functionality as described above.

In one exemplary configuration of the system and method, there are three Producer account types or levels: Basic, Pro, and Premium. In the first two levels, Basic and Pro, the content producer has a profile page that resides on a website controlled by the system owner. This profile page displays a listing of all videos for sale by that content producer through the owner's website. The website may reside on a web server or computer system owned and controlled by the owner or on another web server or computer system which the owner is permitted to use. The Basic and Pro content producer has the ability to upload a profile image and a banner image, and to add descriptive information about themselves including links to their official websites, but this profile page resides within the owner's website and all sale transactions to end-users or “fans” occur from this producer profile page on the owner's website.

In the Premium Producer account type, which is the third and highest level of producer account available through the owner's system, the Premium producer has the option and ability to host the core system functions inside of their own website environment, creating a seamless and custom-branded experience for their end-users or fans. Premium producers specify a sub-domain within their official domain on which the system functions will reside. For example, if a producer's official website domain is “artist.com,” the producer may specify that the system functions will reside at “videostore.artist.com.” The page at “videostore.artist.com” may be designed by the producer or the producer's web developer to look and feel exactly like the other pages within the producer's official site, thereby creating a seamless experience for the end-user.

In other words, in order to purchase videos posted by the content producer, the end-user (fan or customer) is not taken to a profile page within the system owner's domain, as with the Basic and Pro producer account types; here the end-user stays within the content producer's official website where all of the system functions (preview, purchase, and share) occur. This creates a competitive advantage for the Premium producer, increases comfort and security on the part of the end-user, and will theoretically increase the likelihood of the end-user completing a sale transaction.

It is important to note that although the Premium Producer pages are designed and customized to look and feel like the producer's official site, these Premium Producer pages are still hosted on the servers controlled by the system owner, not the content producer's servers. The producer or the producer's web developer creates the sub-domain on the official domain, and configures the DNS (Domain Name Server) to point to the system owner's servers for that sub-domain.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A method of directly connecting a fan with a content producer comprising the steps of allowing the fan to purchase content supplied by the content producer through an electronic distribution system by paying a purchase price and crediting the purchase price directly to an account of the content producer.

2. The method of claim 1, wherein an operator of the electronic distribution system does not control the content provided by the content producer.

3. The method of claim 2, wherein the content producer pays a flat fee to the operator of the electronic distribution system for the ability to provide content for sale to the fan.

4. The method of claim 3, wherein the content producer or fan may post links to the content.

5. The method of claim 1, wherein the content may be accessed through a player that is embedded in different websites.

6. A method that allows a content producer to sell digital content to a fan while avoiding gate-keepers and advertisements; the method comprising the steps of:
collecting a flat monthly access fee from a content producer; the amount of the flat monthly access fee defining storage space, bandwidth, and total number of files;
after the access fee is paid, providing the content producer the ability to set the price for the content provided by the content producer; and
after the access fee is paid, providing the content producer the ability to collect a content fee paid by a fan for access to the content.

7. The method of claim 6, wherein the method is performed on a web server connected to the internet.

8. A computer system that allows a content producer to pay a flat fee and earn money from sales of his content to fans.

9. The system of claim 8, wherein the operator of the system does not provide a gate-keeper function.

10. The system of claim 8, wherein the system does not generate income by selling advertisements.
